(19) United States
(12) Patent Application Publication
(10) Pub. No.: US 2003/0200111 A1
(43) Pub. Date: Oct. 23, 2003

(54) Process for determining optimal packaging and shipping of goods

(76) Inventor: Salim Damji, Woodland Hills, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/418,708

(22) Filed: Apr. 18, 2003

Related U.S. Application Data
(60) Provisional application No. 60/374,056, filed on Apr. 19, 2002.

(51) Int. Cl. G06F 17/60

(52) U.S. Cl. 705/1

(57) ABSTRACT

A process for determining an optimal method and cost of packaging and shipping goods gathers data from sources including order information, product characteristics, packing materials and specifications, labor rates, and shipping and transportation rates in order to determine an optimal configuration for packaging for a designated freight mode and time. The process determines the optimal method by considering any specifications or requirements for the order, lead times, available packaging materials and freight options, and then calculates the least total cost of material, labor, and freight combined. The process is designed to provide the cost of packaging and shipping information in real time, when a buyer and seller are deciding whether to consummate a transaction

### RELATED APPLICATION

This application claims priority from U.S. Provisional Application Serial No. 60/374,056, filed Apr. 19, 2002.

### BACKGROUND OF THE INVENTION

The present invention generally relates to the packaging and shipping of goods. More particularly, the present invention relates to a process for determining the optimal method and cost of packaging and shipping goods within a required time frame. The process is designed to provide the information in real time, when a buyer and seller are deciding whether or not to consummate a transaction.

As electronic commerce evolves, connecting systems will allow for the development of cost efficient and service effective supply chains. Speed and cost reductions will be accomplished through better information to manage product flows, materials, labor, and transportation and shipping carriers. To drive process efficiencies, manage costs, and meet customers' rising service expectations, companies must provide more flexible and high-speed fulfillment operations leveraging key converging technologies.

While technology is contributing many benefits to the supply chain, order fulfillment in the Internet trade environment is becoming increasing costly and difficult as companies struggle to maintain their product margins. Secondly, competition and increased visibility amongst suppliers ready to offer the same or alternative products, are driving prices lower to the extent that suppliers must be careful in managing their costs and product margins on a per-order basis.

One problem lies in the uncertainty of knowing the true shipping and handling costs of a transaction before it is committed to and executed. Charging too little for shipping diminishes product margins and charging too much will force customers to re-think their supplier base. Another problem lies with the quantity of damaged goods during transportation due to poor packaging leading to higher costs and customer dissatisfaction. Buyers are also requiring a higher degree of personalization requiring their orders meet special specifications for their businesses.

In order to alleviate these problems, conventional practice for charging for freight and handling are as follows:

1) Bill for freight as a separate line item after the product has been shipped. This allows sellers to quote or offer pricing for their products under the terms—Freight on Board, Origin. By passing all costs to the buyer, sellers can separate freight costs from the actual cost of the goods. The problem with this practice is buyers end up accepting charges for freight that are uncertain at the time the transaction is agreed to, thus they are not be able to comparison shop amongst a number of sellers based on the total costs of the order. Secondly, there is no incentive for sellers to take care to optimize their packaging and shipping after an order is committed.

2) Some sellers do provide an estimate of the actual costs at the time an order is agreed to. This is usually based on the weight of the product and in some instances the packaging in order to estimate a shipping charge. The problem with this method is that it may take some time or it becomes laborious to estimate the charge; it is most often inaccurate; and it is seldom optimal because it does not consider a set of packaging configurations against a set of freight options to arrive at a least cost method.

3) Quite often sellers simply charge a flat shipping and handling fee or base the fee on purchase volume (i.e. $15 shipping & handling fee if you buy less than $75, $10 charge if you buy between $75 to $125, etc.). While this offers certainty as to what the total cost the buyer is required to pay, it never has any basis on what the actual shipping and handling cost is. This may provide an incentive for buyers to shop around more or may diminish into a seller's margin in the cases when the fee is lower than the actual costs of packaging and shipping.

The problem with all the above methods is that the true costs are only realized after execution at the warehouse level.

A second problem with current methods for determining shipping and handling is that a charge agreed to on the ‘front-end’ is seldom optimal. This occurs because the packaging of a given order alters the final weight and dimensions of a given order. Also, while there are rate shopping software packages available in most warehouse management systems, the rate shopping occurs after an order is packaged thus not optimizing on a packaging configuration that is ideally suited for a particular freight mode.

The specific dimensions and weight of a transport container can have a dramatic impact on shipping charges especially when rate shopping across multiple carriers. In other words, there is no one optimal packaging configuration—there is only a single optimal packaging configuration for a given freight mode based on a certain time frame. When rate shopping across multiple carriers or comparing the increased costs of expediting a shipment comes into play, the number of optimal packaging configurations increases just as the number of freight options. For example, most small parcel carriers use the final total weight of a package for ground shipments as a basis of calculating a shipment fee to their customer. However, using the same carrier for a ‘next day’ shipment changes the basis of the charge from total weight to ‘dimensional’ weight. Dimensional weight is a measurement based on the dimensions of the package—not how heavy it is. Under these two scenarios, the optimal packaging configuration for each would be different. To further complicate the basis for an optimal packaging configuration, freight carriers also have oversize charges and dimensional restrictions for parcels that must be considered. Another example, is when rate shopping between an LTL (less than truckload) and small parcel carrier, both use a different basis for charging for freight—typically the small parcel carrier uses weight on a per package basis whereas as the LTL carrier uses total weight regardless of the number of parcels and a freight class. Because of these differences, it is usually a good tactic to try to limit the number of parcels used when using a small parcel carrier. However, this strategy for packaging is seldom the correct strategy when using an LTL carrier.

Another important consideration in determining a more ‘optimal’ packaging and shipping method is that the degree to which a solution can be the most optimal varies with the selection of packaging materials available in inventory. For example, when using a small parcel carrier for a number of different items weighing in excess in 65 pounds in total, most packagers will uses at least 2 containers to package the items. The reason for this is because the most commonly purchased fiberboard containers are 200# test strength containers that have a maximum weight capacity of up to 65 pounds; however, storing stronger cartons in inventory can allow weights of 80, 95, and even as high as 120 pounds. These containers are not typically carried because they are more expensive and when considering all the different sizes, packagers would have to carry considerably larger inventory of packaging materials that would lead to higher inventory carrying costs. Due to the present invention's ability to calculate the lowest total cost of labor, material, and freight combined, it can recommend to the user when an increase in the material cost is warranted to offset a larger potential expense in freight. Secondly, by introducing a 3^{rd} party such as a packaging house, packaging materials distributor, or even the freight carrier themselves to provide the packaging materials would alleviate the burden the seller would have in maintaining a large inventory of packaging materials. Also, businesses that specialize in fulfillment are much more efficient operationally than sellers/shippers who are less specialized and have smaller shipping and warehousing capabilities. Outsourcing these functions could possibly enable sellers to further reduce their costs of the transaction when offering their goods to buyers. Using the present invention with a third party as the packager and shipper, would then require the 3^{rd} party to be local to the seller, and would either pick up the goods at the seller's location or the seller could drop-off the goods at the 3^{rd} party's location. The 3^{rd} party would then package and ship (perhaps even using another carrier) the goods on behalf of the seller or buyer.

Accordingly, there is a continuing need for a process that provides an accurate and lowest possible cost based on the parameters set by the buyer and seller in order to provide cost and information that may be a deciding factor as to whether or not the parties wish to consummate their transaction. What is also needed is a process that provides potential product package configurations, which are then rated against a different set of possible freight modes to determine the optimal transport and packaging mode. What is further needed is a process which tracks inventory, or has access to a third party packager/shipper, for determining the supplies available to create such packaging configuration scenarios, as well as maintaining inventory and assisting in the determination of which inventory to use or stock compared to a third party packager/shipper. The present invention fulfills these needs and provides other related advantages.

### SUMMARY OF THE INVENTION

The present invention relates to an automated process for determining an optimal method and cost of packaging and shipping goods of given order within a required time frame. The process is designed to provide the cost of packaging and shipping information in real time-when a buyer and seller are deciding whether or not to consummate a transaction. The process utilizes the data gathered from sources containing the order information, product characteristics, packaging materials and specifications, labor rates, and shipping and transportation rates in order to determine the optimal configuration for packaging and the designated freight mode. The invention determines the optimal method by considering any specifications or requirements for the order, lead times, available packaging materials, and freight options and then calculates the least total cost of material, labor, and freight combined. The data is then used as a basis for pricing the transaction and also producing a work order at the warehouse level or to a 3^{rd} party that can carry out the fulfillment and transportation of the goods.

The process of the present invention comprises the steps of obtaining order information, including the availability of the goods and the delivery time which the goods must reach a given destination. Physical characteristics of the goods, including dimension and weight, are retrieved. Preferably, such physical characteristics can be retrieved from a database into which these characteristics were previously entered. It is then determined whether any predetermined packaging specification or unit packaging specifications apply to the goods. These specifications may also be retrieved from a database.

One or more packaging configurations are then determined for the goods. Such packaging configurations may be based on the physical characteristics of the goods, the amount of the goods, and any applicable packaging or unit packaging specifications. The packaging configurations may also be based on input from either the seller or buyer.

The type and amount of packaging material requirements for each of the packaging configurations is then determined. The packaging material and labor costs for the one or more packaging configurations is then calculated.

The process of the present invention may evaluate the packaging inventory of the seller to determine if adequate materials are in inventory for the one or more packaging configurations. The invention is also preferably connected, or has access to, a third party packaging/shipping source to determine whether to use the third party. When using a third party, a third party's packaging materials inventory, freight weights and options available, labor rates and applicable service fees are retrieved.

The combined dimension and weight of the goods and packaging materials for the one or more packaging configurations is then determined. These packaging configurations are then rated for transport load options against available carrier freight modes for delivery of the packaging configurations by the delivery time. The invention takes into consideration all appropriate rules per carrier, such as oversize, over weight, maximum weight, maximum dimension, etc. A cost is then provided to the user for each transport load option. This is preferably done in real time to provide the necessary options to the seller and buyer to enable them to make an informed decision before consummating the underlying order transaction. An optimal transport load option is then selected which is most desirable to both parties. Although this may be the least expensive transport load option, the buyer may be willing to pay an increased fee to have the goods delivered sooner. The present invention can provide this information.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIGS. 1A-1E are flow charts illustrating the steps taken in accordance with the present invention;

FIG. 2 is a diagram illustrating potential transaction types and sources of order information used in accordance with the present invention;

FIG. 3 is a diagram in the form of a matrix illustrating the manual input or retrieval of physical product characteristics and predetermined packaging specifications used in accordance with the present invention;

FIG. 4 is a table listing product characteristics of exemplary goods used in accordance with the present invention;

FIG. 5 depicts an exemplary template for packaging specifications used in accordance with the present invention; and

FIG. 6 depicts an exemplary template for a Bill of Materials used in accordance with the present invention.

### DETAILED DESCRIPTION OF THE PREFERRED EMBODIMENTS

As shown in the drawings for purposes of illustration, the present invention resides in a process of determining the optimal method and cost for packaging and shipping goods. This is done in “real time ” such that a buyer and seller may rapidly obtain the information in order to determine whether to consummate a transaction. The present invention enables both parties to realize the total cost of the purchase broken down between the selling price of the goods, costs of shipping and handling, and any applicable taxes. The packaging configuration and lead times for delivery can also be manipulated in order to view and compare the different costs over more customized scenarios such as with expedited delivery times, special packing materials, etc.

The optimal method is determined by calculating the least total cost of material, labor, and freight costs combined. In carrying out the process, the invention also provides for a collaborative platform allowing multiple parties to participate in either providing vital data or participating in the physical fulfillment and transportation of the goods or both. The present invention determines the optimal method prior to acceptance of a transaction between a buyer and a seller in order to provide costing information that may be a deciding factor as to whether or not the parties wish to consummate their transaction. This is accomplished by connecting to various systems and databases containing the order information, product characteristics, packaging materials and specifications, labor rates, and shipping and transportation rates in order to determine the optimal configuration for packaging and the designated freight mode. The invention determines the optimal method by considering any specifications or requirements for the order, lead times, available packaging materials, and freight options and then calculates the least total cost of material, labor, and freight combined. The data is then used as a basis for pricing the transaction and also producing a work order at the warehouse level or to a 3^{rd} party that can carry out the fulfillment and transportation of the goods.

Conventional practice in charging for freight and handling do not realize the true and optimal costs of distribution. An accurate and optimal cost can only be realized after execution at the warehouse level. This occurs because the packaging of a given order alters the final weight and dimensions of a given order, and the number of items that may be placed in a given container. Secondly, the specific dimensions and weight of a transport container can have a dramatic impact on shipping charges especially when rate shopping across multiple carriers. While shipment rating software exists in the market, the present invention considers an optimal packaging configuration for each different freight option in order to determine the lowest total cost of executing the transaction. Determining an optimal packaging configuration independent of carrier rating does not lead to the lowest total cost. In fact, utilizing the least cost method of the present invention demonstrates the least total cost does not always amount to the least packaging cost or the lowest shipping cost, but rather the lowest of the combined costs. The invention also allows for a user to manipulate any variables of the order on-the-fly in order to compare charges under different scenarios. For example, the packaging and freight method can be altered if either the buyer or seller had a specific packaging requirement or specification due to the buyer's material handling equipment, customized packaging materials, etc. Also, the buyer may alter the product mix, lead times, etc. for the order, in order to compare different packaging and shipping costs. The seller may choose to purchase new stock packaging materials, add to the available packaging materials for the order, use a different shipping carrier or introduce a 3^{rd} party who specializes in packaging and freight forwarding and has a greater inventory of packaging materials thus recognizing additional efficiencies and cost reductions. All these options can be decided upon quickly and easily by connecting and collaborating with the different parties and databases that host the information needed to complete the transaction. Once the packaging and freight mode is determined a work order is produced that either the seller or a designated 3^{rd} party must execute.

The invention can also be utilized as a stand-alone application not connected to a buyer or seller. For example, a user can utilize the invention in order to determine an optimal method and cost for the purposes of producing a pricelist for products that include the cost of distribution to specified locations (Freight on Board Destination pricing). Another example is if a buyer typically pays for the shipping and transportation based on FOB Origin terms, the buyer may want to check to see if the seller is billing fairly for freight. This would be done by entering the products and characteristics for an actual order and calculating the optimal method by utilizing a common list of packaging materials, and freight rating tables. This method may also be used by a packaging materials salesperson or a warehouse worker in order to determine the best selection of packaging materials to keep in stock.

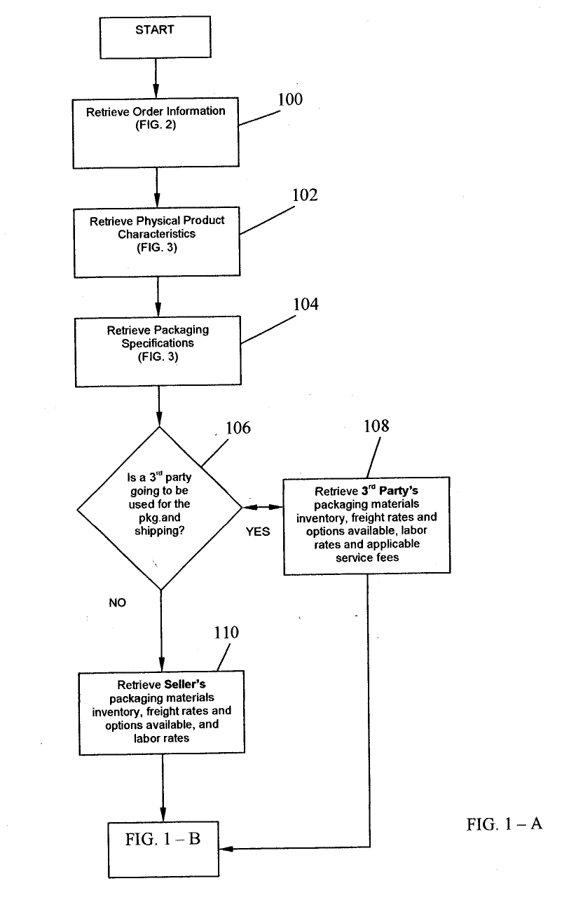

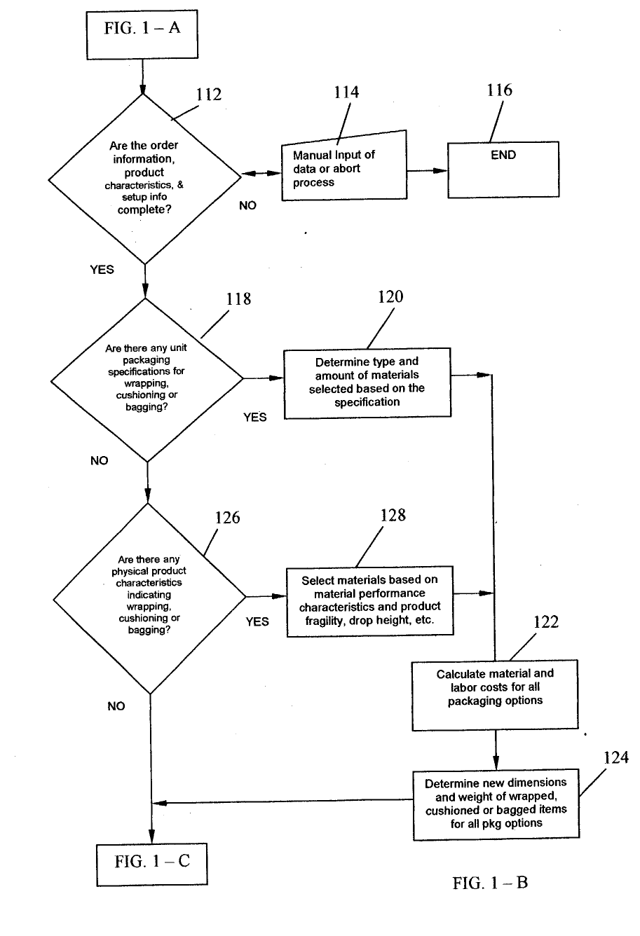

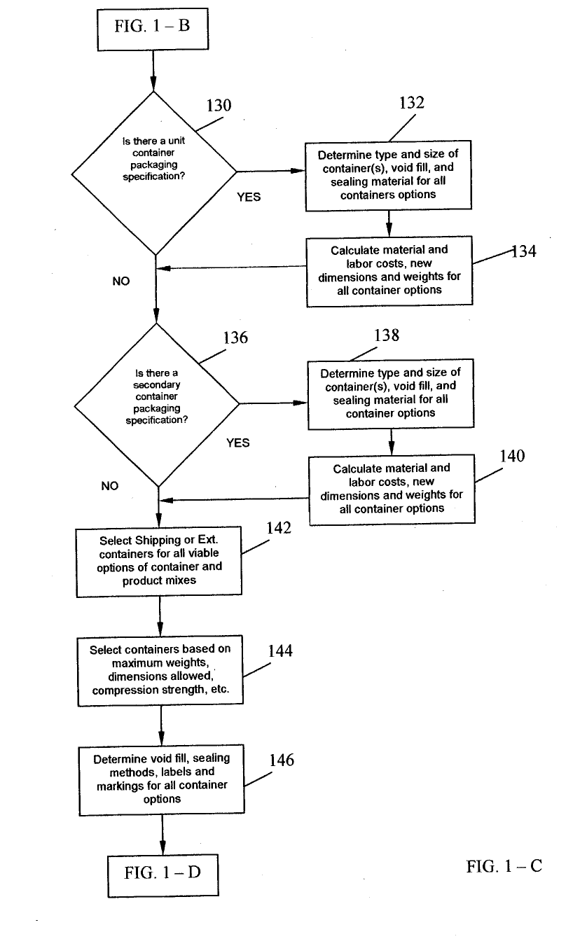

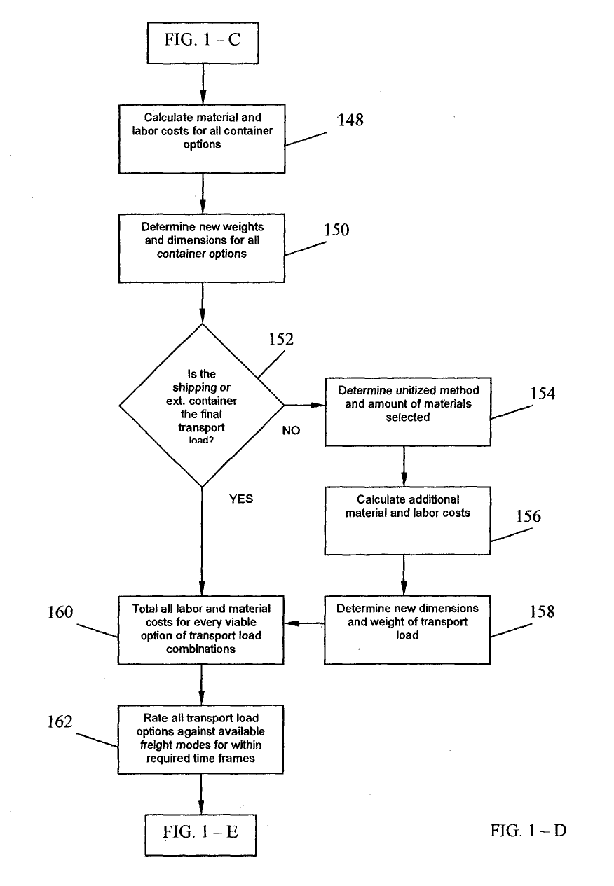

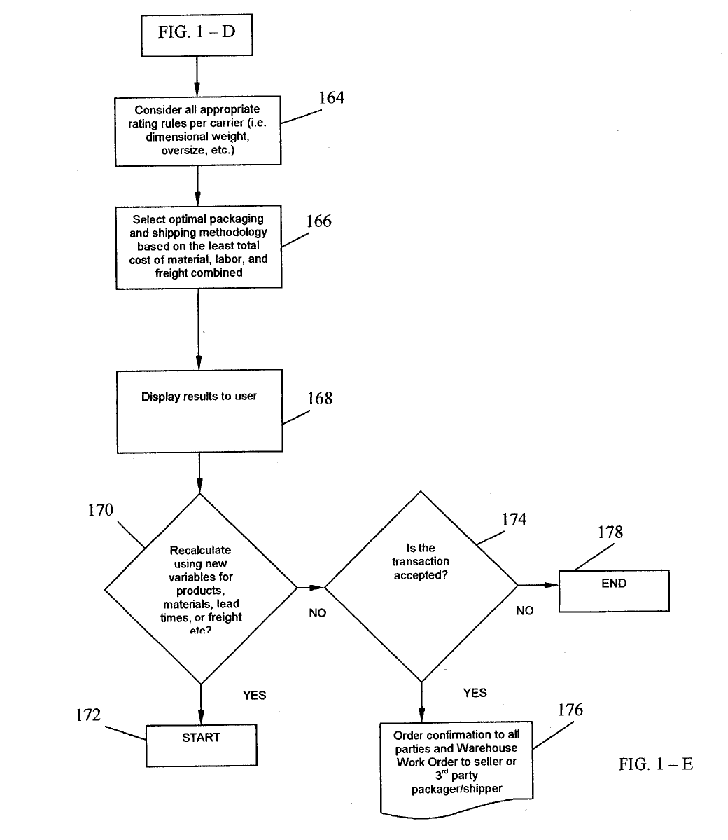

FIGS. 1A-1E are flow charts illustrating the steps taken in a particularly preferred process of the present invention. The present invention first begins by receiving data from a transaction or an offer of a transaction (pricing request) between a buyer and a seller (100). The invention must first consider what is being purchased or sold, by when it is required, and where does it need to be delivered from and to. The data related to a typical transaction would consist of the items themselves (referenced by item or part numbers and descriptions), the quantities required, the unit prices, the origin and delivery destination of the products, the required lead times and the terms.

Order information can be accessed from an order engine or similar database containing the relevant data. The invention may be integrated with this database or may communicate with it using electronic protocols such as XML, HTML, etc. It can also be re-keyed for purposes of responding to a Request for Quote (RFQ) for example.

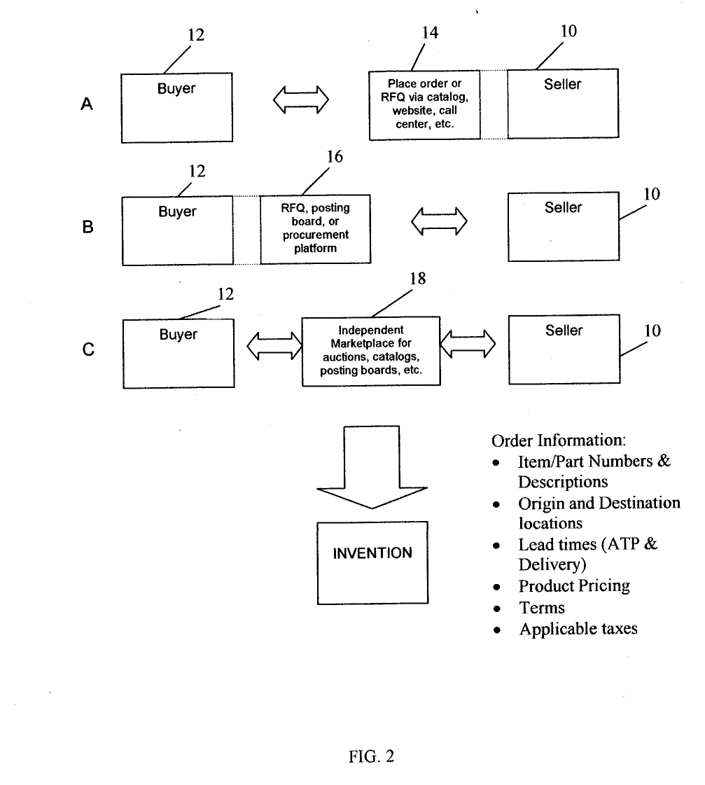

FIG. 2 is an illustration of the types of commercial transactions that the invention may extract order information from. In most types of transactions where a sale is made between two parties, it is usually the seller (10) that offers its products for sale to the buyer (12) as a buyer ‘shops’ from a catalog of items (either electronic or paper) (14). A seller can also offer items for sale to a number of buyers at once in the form of an auction via 3^{rd} party electronic marketplaces, or another medium that the buyer is electronically connected to for procurement purposes. Buyer's can also post an RFQ (reverse auction) on a marketplace, procurement site or similar application (16). In all cases, the medium for the transaction could be electronically over the web, via Electronic Digital Interface (EDI), or communicated over the phone into an order entry system, etc. (18). Whether the transaction initially takes place electronically or not, the data can eventually be keyed into an order entry system on the seller's side that communicates or integrates with the present invention.

The invention will determine the time at which the goods are available for shipping by considering their ATP (available-to-promise times) listed by the seller. This is typically known on an item-by-item basis, or the order engine would be able to check inventory of the seller to see if an item is in stock or when it would be available. If products have different availability times, there would be some indication as to whether or not to ship all items in one lot (at the latest availability) or as separate shipments.

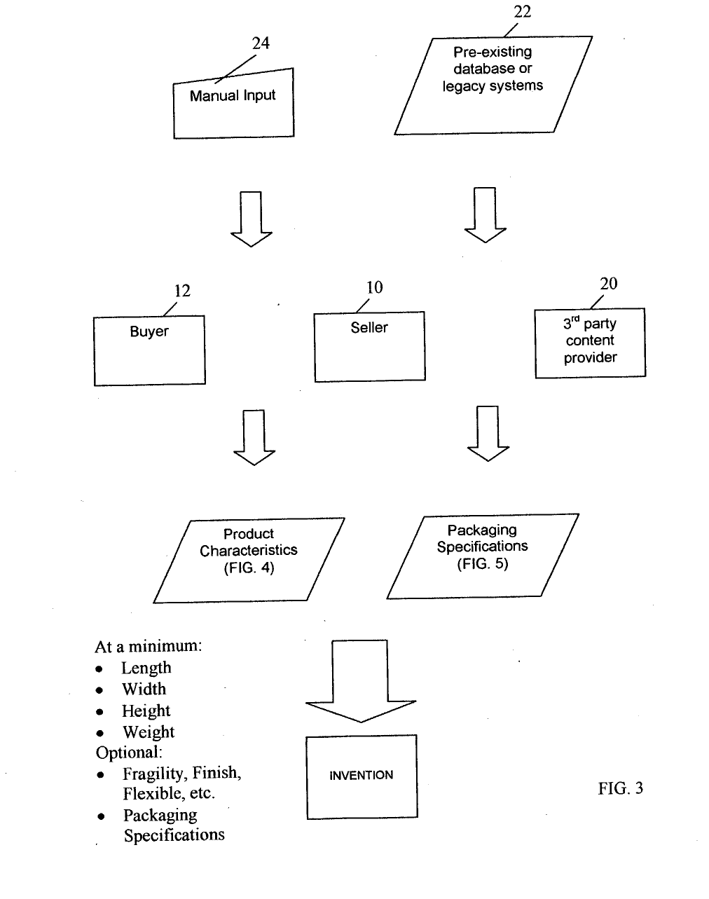

Once the present invention has the data related to an order for a product or number of products, it must obtain data related to the physical product characteristics (102), which describes the physical nature of each individual item referred to in the order information. With reference to FIG. 3, the present invention at a minimum, requires the weight and the dimensions of the items for the order it is processing. This data is usually provided by the seller (10) when it is the seller (10) offering the products or may be offered by the buyer (12) if the buyer (12) has posted a request for the product(s). A 3^{rd} party (20) may also provide product content that includes the physical characteristics of the products. Such data may be obtained from pre-existing databases or legacy systems (22) by either the seller (10), buyer (12), or 3^{rd} party (20). If, for whatever reason, there is no data available regarding the physical characteristics it may be keyed in manually (24) at the time of the transaction.

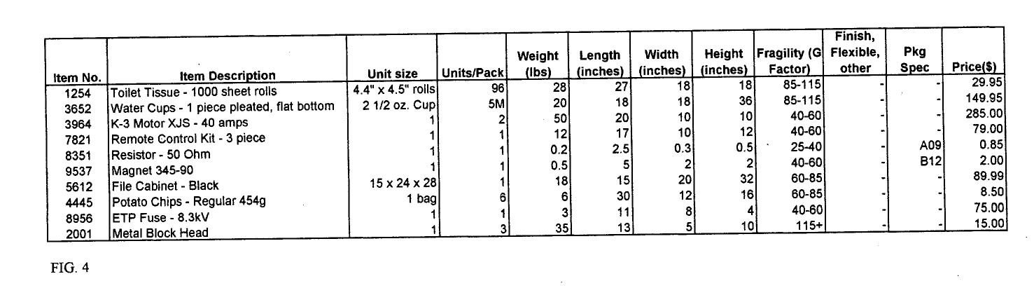

Many catalog databases contain open fields associated with physical product characteristics for every product SKU or item, but are seldom filled. FIG. 4 illustrates an example of a table or parallel database that lists various product characteristics of different types of products. Such a table or database can be newly created or used to update an older database if one was not originally available. The open fields or parameters for physical characteristics that may be gathered for a given item are (but not limited to): weight, length, width, height, fragility, whether the item is flexible, finish type, and can also have a packaging specification associated with it. Flexible items are items that can be rolled, folded, or are not rigid in nature. This would indicate that the dimensions of the item can be altered. The finish type would be associated with a surface on an item that could scratch, corrode, etc. This would indicate some type of wrapping should be used, specialty bag, or the item should not be in contact with itself or another item. For items that are fragile, the invention would determine a cushioning requirement based it's fragility measured in Gs. An example of a table packaging design engineers would refer to as for a method of determining G's and drop heights are described in the following tables:

TABLE 1
Approximate Fragility of Typical Packaged Articles

| | |
|---|---|
| Extremely Fragile | 15-25 G's |
| Aircraft altimeters, Winchester hard disc drives | |
| Very Delicate | 25-40 G's |
| Medical diagnostic apparatus, X-ray equipment | |
| Delicate | 40-60 G's |
| Computer display terminals and printers, electric | |
| typewriters, cash registers | |
| Moderately Delicate | 60-85 G's |
| Stereos and television receivers, floppy disc drives | |
| Moderately Rugged | 85-115 G's |
| Major appliances and furniture | |
| Rugged | 115 G's and |
| Table saws, sewing machines, machine tools | up |

TABLE 2
Typical Drop Heights

| Weight Range Gross | | Drop Heights |
|---|---|---|
| Weight in lbs. | Type of Handling | in Inches |
| 0-10 | 1 person throwing | 42 |
| 10-20 | 1 person throwing | 36 |
| 20-50 | 1 person throwing | 30 |
| 50-100 | 2 people carrying | 24 |
| 100-250 | Light equipment | 18 |
| | handling | |
| 250+ | Heavy equipment | 12* |
| | handling | |

*Palletized products may receive drops of six inches

This allows users to choose from a list of similar items in order to select a fragility measurement. The invention would also be user friendly for other optional characteristics (such as for surface finish) allowing a user to simply select a characteristic that describes the item as being needed to stay dry, careful not to be scratched, etc.

The physical characteristics can come from a variety of different sources such as being inputted manually by a user at any time, or can also be provided by designated users. For example, a worker receiving goods into a warehouse could input the required data prior to when it is available for sale. If the item is available for sale on a marketplace and is a commonly sold item, the content could be provided by one of the vendors or the marketplace itself, and then reused for future buyers and sellers. The item could also be a uniquely manufactured part, in which case either the buyer or seller would provide the data.

The next step is to check if there are any packaging specifications associated with any items selected as part of the order, or if there are any special packing requirements made by the seller, buyer, or a 3^{rd} party (104). This is usually done because a particular item may, for example, be prone to moisture, static, or it may be highly fragile or have a high value.

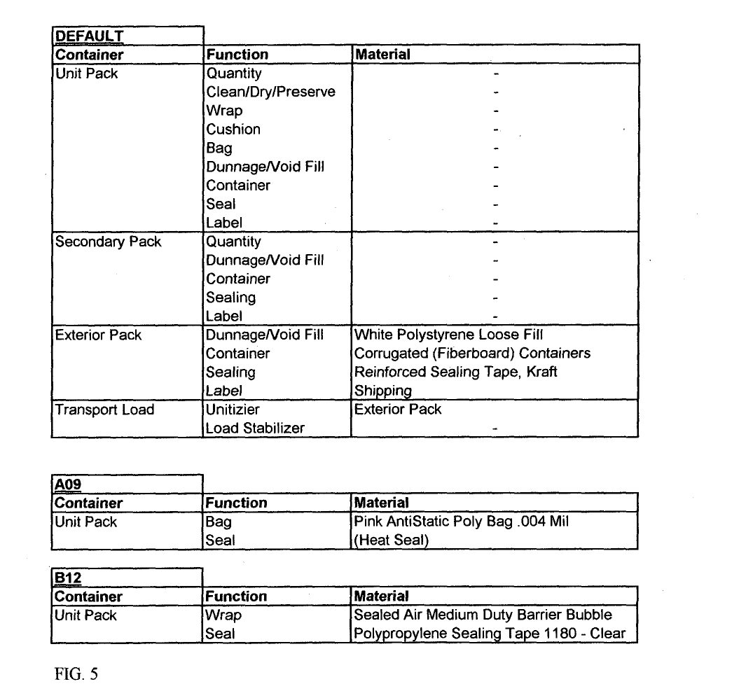

The packaging specification is a list of packaging steps indicating whether or not an item has a special packaging material requirement. It will be noted that items 8351 and 9537 of FIG. 4 have a predetermined packaging specification. FIG. 5 illustrates a table of packaging specifications, some of which are default and others of which are selected by the user. The packaging specifications (A09 and B12) of item numbers 8351 and 9537 of FIG. 4, for example, are listed in FIG. 5 and indicate not only the type of material required, but also what stage of the packaging process or function the material would be used for (i.e., the unit pack stage). For example, an item may require to be enclosed in some anti-static material packaging such as a bag, and the ‘bagging’ function is a step that takes place after wrapping but prior to placing an object in a container. Although items are already required be in a unit container in order to be inputted into the product database, some items may still not have unit containers. These cases usually occur when an item is picked from bulk, or it has some special requirement or procedure needed to perform prior to it being packed in a unit container. The creation of a packaging specification for an item would ensure the packager of following a given requirement.

Also, the invention would also allow the user to add additional instructions and materials to the specification. For example, an item may require cleaning, kitting or some assembly of parts could be built in. This would allow the user to customize the packaging and handling of particular items. After recording a packaging specification, the present invention will keep the data in memory along with the order information and physical product characteristics.

If an item has a characteristic to it that requires a special packaging requirement (for example, the item is highly fragile, prone to moisture or static, etc.) it may have a packaging specification flagged to it. However, items may be fragile for example, but without a packaging specification; therefore, by identifying a fragility rating or G-factor in the physical characteristics for a given item, the invention in subsequent steps will be able to create a packaging specification.

The next step is to query the seller for instructions as to whether or not a 3^{rd} party packager will be used (106). If a 3^{rd} party packager is to be used, the 3^{rd} parties packaging materials inventory, freight rates, and options available, labor rates, and applicable service fees are retrieved from a database of the 3^{rd} party (108). If a 3^{rd} party is not going to be used for packaging and shipping, the seller's packaging materials and inventory, freight rates and options available and labor rates are retrieved (110).

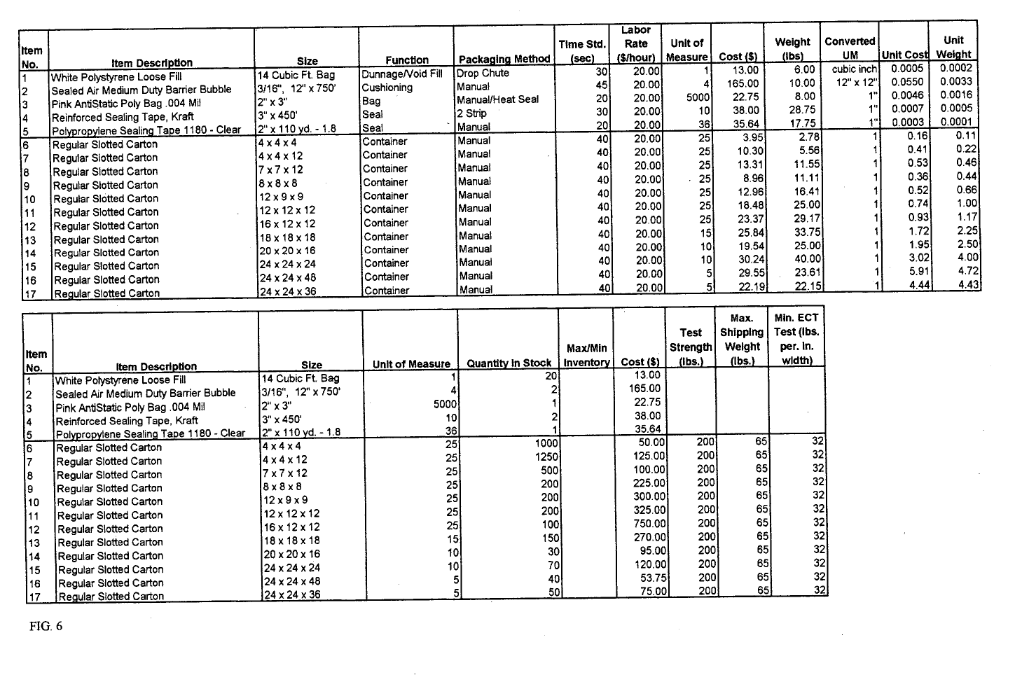

In either case, a list of packaging materials or the Bill of Materials (BOM) is needed to package the order. With reference to FIG. 6, an exemplary BOM used in accordance with the present invention is illustrated.

As a minimum, the packager must be able to provide materials for void fill, shipping container(s), and means for sealing the shipping container(s). The list is somewhat complex because each material listed also has a method of applying the material (more than one method is possible) and the function in the packaging specification it can be applied to. This provides a vital link in bringing the process of packaging the item together with any packaging specifications, and in being able to accurately calculate the labor and material costs of each order. A material can also have more than one packaging method and function.

The packaging method can be a manual labor procedure, or a more automated method such using a machine to fill, dispense, seal, etc. In any case, a standard in terms of time (human or machine, or both) is associated with it. This requires a labor rate to be provided in order to measure the appropriate labor charges. For example, a material such as polystyrene loose-fill would have a function of ‘dunnage/void fill.’ It's packaging method would be ‘use a drop chute as a dispenser.’ The drop chute method may have a 30 second time standard for which each time it is used a labor cost is calculated. The amount of loose-fill used would be calculated by taking the volume of the container and subtracting the volume of the items in the container. Another example is using a six strip sealing method for taping a carton. In this case, the amount of material used for the sealing of the container is calculated by considering the size of the flaps the carton is applied to and the number of strips.

The user can set up a default specification for their material database while also allowing for more a customized specification for a specific product that is an exception to the normal packaging process. For example, the user can configure their default functions to use loose fill as dunnage/void fill, kraft sealing tape for sealing, and corrugated cartons for all containers, etc. However, if some items have unique product characteristics or packaging specifications, this would trigger the invention to use the necessary material rather than the default.

The user who sets up the BOM would also need to input the cost of labor they wish to apply against the standardized labor times for the packaging methods. The user may want to add a markup to their labor rates as well or simply have a flat service charge if they are a 3^{rd} party packager. The labor rates will be separated for different classes of work, will include all employee costs, and other items as the user wishes to define. For example, the labor rate for a general worker in the warehouse may be $20 per hour, while the labor rate for a machine operator could be $28 per hour.

Obviously, the BOM will contain a number of materials with the same functions. The invention will choose what materials to use based first on the required packaging specification, performance characteristics, the geometry of the items, etc. For example, the fragility rating of the item would dictate the actual type(s) of cushioning material that can be used. The materials listed in the database are also sorted by type and list performance characteristics associated with those materials. For example, containers would indicate their maximum recommended weight of container and contents, edge crush test, and bursting (mullen) test. Cushioning materials will include deceleration cushioning curves, static loading limits, etc. and other measurements required to make cushioning material determination.

Each material will have an identification number, description, unit of measure, unit cost, and unit weight, as shown in FIG. 6. The user will input their cost for the material in the unit of measure it is purchased. The invention will convert the unit price into the unit of measure or “unit of usage ” required to calculate a material and labor cost. For example, a user may purchase a roll of kraft sealing tape for $3.80 and input this price next to the description for Reinforced Sealing Tape, Kraft; Size 3″×450 feet. Since the sealing function calls for a unit of measure in inches, the tapes unit price in inches automatically calculates to $0.00070. The same is done for unit weight.

The invention also monitors what materials are in inventory, their amounts, re-order points (maxs/mins), and re-order quantities. The user also has the option to directly procure materials from a packaging materials distributor electronically. As materials are depleted or procured, the inventory amounts adjust accordingly. The invention will also monitor the historical usage of materials that are used and for materials that were not purchased. For example, if a particular application owner were to carry only 15 container sizes in stock, the invention would monitor which sizes would have been most commonly used from a list of 500+sizes. This would allow the user to re-order materials in sizes that better fit a usage trend.

Freight rates must be obtained or extracted from a database used in accordance with the present invention for either the seller or 3^{rd} party. For small parcel carriers such as UPS, FedEx, etc., rates are published. The present invention will maintain the most recent rates from the major carriers as they become available. The invention will also provide for LTL (less than truck load) carriers and will utilize published rating tables as well. Generally, the invention is designed to show comprehensive freight tables for a multitude of major carriers.

The rating rules for each carrier are also integrated in the system, ways to calculate dimensional weight, oversize charges, etc. The user may also indicate any discounts they may have from a carrier, or may want to add a markup cost to their freight. The shipper (either the seller or 3^{rd} party) would simply need to indicate what carriers they wish to rate shop against along with any discounts structures.

The invention will allow the shipper to input their rating tables for carriers they may use but are not large enough to have published rate tables. In the case of LTL carriers, more information such as freight class would be required. This would have to be inputted at the time of rating on a per order basis depending on the type of freight.

The present invention then determines if it has sufficient amount of information to produce a packaging and shipping solution (112). If there is insufficient data, the user may be prompted to input the data (114) or the process can be aborted (116). The user can also setup the application to respond in a desired fashion. For example, if the product characteristics are not complete, the seller or any user could be prompted to make an entry in a table (i.e. FIG. 4) during the course of a transaction. Another example, is if there is not enough sufficient data in the seller's or 3^{rd} party's Bill of Materials to meet the requirements of a packaging specification, the invention could be instructed to utilize a substitute material from a universal database of packaging materials. However, if the transaction does end up confirmed, the seller may have to procure new materials.

If it is determined that the order information, product characteristics, and set-up information are sufficiently complete to run calculations and comparisons, the invention will determine if there are any items that have unit packaging specifications for wrapping, bagging, or cushioning (118). If an item is identified has having a unit packaging specification, the invention will first determine the amount of material required based on the packaging specification and the quantity of items (120). This will require a series of steps and by first matching the BOM database to the product's packaging specifications. The BOM would have materials stated in a unit of measure conducive to calculating the amount of material required for wrapping, cushioning, etc. Once the unit weight, unit material and unit labor cost is extracted from the BOM, the invention determines the amount of material required.

The following formulas can be used for calculating wrapping, cushioning, and bagging materials lengths and widths for a given item.

Wrapping Material

Wrap Length=(2×width of Item)+(2×height of item)+2

Wrap Width=length of item+height of item+1.5

Roll Cushioning Material

Roll Cushioning Length=number of layers×(2×width of item+2×height of item+1)

Roll Cushioning Width=length of item+height of item+1

Cut Cushioning Material

Length of Bottom Pad=length of item

Width of Bottom Pad=width of item+2×thickness of cushioning

Thickness of Bottom and Top Pad=Thickness of cushioning

Length of End Pad=length of item+2×thickness of cushioning

Width of End Pad=height of item+2×thickness of cushioning

Thickness of End Pad=thickness of cushioning

Length of Side Pad=length of item

Width of Side Pad=height of item

Thickness of Side Pad=thickness of cushioning

Flexible (Bag) Material

Length of Bag=2×width of item+2×length of item+3 to 5

Width of Bag=length of item+depth of item+3 to 5

All figures listed above are in inches. It should be noted that the formulas listed above can also be altered to account for the usage of usage or waste factor. Of course, it will be appreciated by those skilled in the art, that these formulas are merely exemplary, it being within the scope of the invention to determine the amount of material required for any particular item by other methods as well.

The invention could then calculate the incremental unit material and labor costs for packaging according to the specification (122), and also the new weights and dimensions of the items being wrapped, cushioned, or bagged (124). If, for example, an item is wrapped and cushioned, then the invention would keep track of the new dimensions after the first procedure of the given item before sizing the item again for the next procedure.

Even if there are no unit packaging specifications for the selected items in the order, the next step is to determine if items had physical product characteristics that require cushioning or wrapping materials beyond standard void fill or dunnage material (126).

If a fragility description were given for an item such as determined by a comparison to Tables 1 and 2, the invention then would look up its' fragility rating and weight. The weight of the item determines the drop height, and the G-factor is used for fragility. The load (psi) of the item is also determined by dividing the weight by the surface area. All these measurements are compared to a particular cushioning material's ‘cushioning curve’, static loading measurements, and other physical properties as provided by the materials performance characteristics listed in the Bill of Materials. Generally, most cushioning materials will not have many performance measurements listed in the BOM, but some materials will offer properties for measuring creep, temperature, and buckling. Also, a unit container for item may be assigned if the cushioning material used is a “cut ” and not a “roll ” material.

The invention will best select a cushioning material based on the information that is provided (128). The amount of protection a material will provide will vary with the thickness of the material used. However, the more the material that used, the more of an increase in the cost of material is incurred, perhaps labor used to apply it, and an increase in the weight and size of the item. The material and labor costs are calculated (122) as well as the new weight and dimensions of the cushioned item (124). If more than one cushioning material is acceptable, then the invention will choose all the options available provided each one is different not only in cost, but also in altering the weight and size of the object. For example, if a second cushioning material is more expensive, but offers no reduction in weight or the size of the object, the invention would then drop this selection as an available option. The invention would then tabulate the material and labor costs, and new weights and dimensions of the options available before moving to the next step.

Another physical product characteristic requiring additional packaging materials is surface finish. The surface of an item may be described as requiring additional protection because the item is easily scratched or prone to moisture, static, etc. Under the BOM, there will be some bags, or wrapping materials that would offer protection for however the surface finish is described under the physical product characteristics. As with cushioning materials, the materials used for surface finish protection are calculated in the same manner, keeping record of all the viable alternatives in proceeding to the next steps.

The invention then determines if there is a unit packaging specification (130) for the goods in question. If there is a packaging specification associated with the unit container then there may be more than one unit of an item allowed in a unit pack. In this case, the invention will alter the quantity of unit containers needed.

The type and size of containers, void fill, and sealing material for all container options is then determined (132). A unit container is selected from the BOM on the basis of all the possible container sizes that will accommodate the object to be packed. This is determined by first selecting the containers that can dimensionally fit the required object; and secondly, by short-listing the containers that do not meet the performance requirements for maximum weight allowances, etc. In this case, the required object may be single item or a number of items already wrapped, cushioned, etc. If there is more than one object to be fit into a unit container as called-out in the specification, then the possible geometric configurations of the object may vary. For the purposes of this invention, it is determined that if more than one item is in a unit container, that they will be stacked next to one another with the height of the new object being the total of the smallest dimension of the individual item. For example, 6 items measuring 8″×3″×2″ will be stacked to give a final measure of 8″×3″×12″. Likewise, another possibility is the item could form 2 stacks, each measuring 8″×3″×6″ for a total unit size of 8″×6″×6″.

The possibilities of final dimensions of the object to be unit packed are then checked against the available choice of unit containers listed in the BOM. This can easily be done by a means of listing the dimensions of the object and potential container in descending order and making sure that the highest, middle, and lowest dimension of the object is greater than the respective numbers of the container. For example, if the object of 8″×3″×12″ was be checked against two container sizes of 10″×6″×6″ and 12″×4″×10″. It would then be determined that the second container of 12″×4″×10″ could only fit because by comparing the numbers for an object turned on it's side is 12×8×3 versus 10×6×6 and 12×10×4. 10×6×6 container doesn't work because the 1^{st} and 2^{nd} highest number of ‘10 and 6’ is not greater than ‘12 and 8.’ However, if the object of 8″×6″×6″ was be checked against two container sizes the 10×6×6 would fit and not the 12×10×4. If more than one container listed in the BOM can be used as a unit container, then the invention will keep a record of the possible containers as an option for the lowest cost solution.

The present invention may employ the use of U.S. Pat. No. 5,430,831, entitled Method of Packing Rectangular Objects in a Rectangular Area or Space by determination of Free Sub-areas or Sub-spaces, the contents of which are hereby incorporated by reference. It should be noted, however, that reducing that amount of free space in a given container does not necessarily lead to an optimal solution. The best way to arrive at a most optimal solution is to test as many possible packaging configurations against the available carrier options.

As stated above, to complete the unit container requirement, the required amounts of void fill or dunnage, sealing of the containers, and any labels and/or marking for all unit container options are also determined. This is first done by checking to see if there are any packaging specifications for a given product (as material requirement) and then by searching the BOM for the designated void fill, sealing materials, etc. The material and labor costs and new weights and dimensions of the completed unit containers options are calculated for each container option.

As there may be several possible container size options, the invention will allow the user to select a sub-set of the options to be determined as being the ‘best.’ The criteria for the ‘best’ can also be manipulated. For example, the invention could be set to choose the best six options that are considered to be: the 1^{st} and 2^{nd} lowest cube or volume measurements of the containers; the 1^{st} and 2^{nd} lowest cost (material+labor) options thus far; and finally the 1^{st} and 2^{nd} lowest weight combinations. If a best option were repeated, then it would not be duplicated or substituted unless the number of options was increased. It should be noted that the lowest cost option would also include the void fill and sealing costs as well needed to complete the unit container.

The next step is to check if there is a packaging specification for an intermediate or secondary container (136). Similar to the steps taken for the unit container packaging specification (130-134), if there is a secondary container packaging specification, the type and size of containers, void fill and sealing material for all container options (138) is determined. The invention then calculates the material and labor costs, new dimensions and weights for all container options (140). If the packaging specification for a secondary container is necessary, this could possible lead to a number of secondary container options. It is assumed that items having a secondary container packaging specification would not be co-mingled with different line items unless otherwise noted. As described previously, a new best set of options may be selected, instead of all options, before proceeding further.

The actual configuration of the exterior or shipping container is then determined. Whether or not there have been unit or secondary packing activities prior it this step is irrelevant, as this step is necessary under all scenarios—unless a single packaged unit container has been configured for the entire order and is determined to be shippable.

Since there may be multiple line item orders, some with or without unit packaging, some with more than one quantity, etc., a more careful geometric configuration may be desired at this level than previously made at the unit and secondary container levels (130-140). Also, the exterior container(s) is what gets rated by the different carrier alternatives, and therefore the higher number of exterior container configurations or options that can be used, the more likelihood of arriving at an optimal least cost solution.

The invention will consider the different geometrical configurations based on the placing an object next to another object and therefore changing the geometry of the combined object. However it is assumed, unless noted otherwise, that a line item with more than a quantity of one, would be kept closely with the same items. Therefore, the geometric shape of number of the same item can be combined into one object representing and fitted into a shipping container—up to the weight and size restrictions of a given container.

Also, the invention must consider the number of combined units (exterior containers) in relation to the number of objects. For example, 1 object would be placed in 1 exterior container; 2 objects could be placed in 2 separate exterior containers or combined into 1 container; and 3 objects could be placed in 3 separate exterior containers, 2 exterior containers having 3 different combinations, or 1 exterior container combining all 3 objects. Since the number of geometrical combinations increase exponentially as the number of unit packs increase, it may be necessary to use the best options method described above and some additional cubing or mathematical algorithms to reduce the number of geometrical combinations.

For the purposes of this invention, the user would be able to choose a selected number of ranked choices based on particular strategies. For example, the invention could select the top 3 choices for a) the lowest number of containers b) lowest total weight c) the lowest total cost of material and labor c) lowest total volume of containers, etc. These would all be viable container options that should be rated against all available carrier options. However, it will be appreciated by those skilled in the art, that there may be packaging specifications, which are predetermined for the exterior container of the particular items or goods selected. Of course, such packaging specifications, would be followed.

As with the unit containers, the exterior or shipping containers are selected (144) on the basis of the size of the objects placed in the container, and the performance requirements of the containers selected. Exterior or shipping containers selected from the Bills of Materials must meet the maximum weight and dimension requirements, and other performance measures.

To complete the exterior or shipping container requirement, the required amounts of void fill or dunnage, sealing of the containers, and any labels and/or marking for all unit container ‘best’ options are also determined (146). This is first done by checking to see if there are any packaging specifications for a given product (as material requirement) and then by searching the BOM for the designated void fill, sealing materials, etc. The material and labor costs and new weights and dimensions of the completed unit containers options are calculated for each container option (148 and 150).

The next step is to determine if the exterior or shipping container(s) is the final transport module (152). For example, if there are a number of shipping containers, the packaging specification may call out for them to be unitized prior to freight rating. In any case, if the invention plans to use a freight carrier that requires a unitized load or if the buyer requires a unitized load (i.e. due to it's material handling equipment), a unitized load or a possible set of unitized loads would be configured. The unit load could be a larger container, pallet load, slipsheet load, etc. These materials would be available and listed by function in the BOM. Also, stabilizing materials may be used such as materials used for strapping or wrapping the unit load may be required and must be determined (154). The material and labor costs are tabulated similarly to previous steps (156). The invention would run a set of algorithms based on the characteristics of the shipping or exterior containers in order to determine the configuration of the final transport load (158).

The set of final transport load options are then rated. The invention determines the speed of the delivery requirement and what carriers can possibly provide delivery between the origin and destination locations. It then looks up the appropriate freight tables, applies the any freight rules, restrictions, and freight classification (weight, dimensions, etc.) on a per carrier basis, and determines the freight cost for each transport load option (160 and 162). The invention will also take into account the additional or special charges per carrier (164).

Once a freight charge is determined for each transport load option, it is combined with the labor and material costs for that particular configuration or option. The invention then selects the configuration from the set of options that has the least total cost of material, labor, and freight costs (166). The single optimal packaging configuration and shipping mode may be selected, however, preferably a plurality of optimal packaging and shipping methodologies are selected to provide the user choices. The results are then sent to the medium the buyer and seller are using for making a sales transaction for display (168). The results would indicate the cost of packaging and shipping the selected order within the required time frame, along with a recommended set of packing and shipping instructions. Either the buyer or seller may re-configure the variables associated with the product mix, the order itself, packaging materials, freight options, etc. to re-run the invention again perhaps providing more favorable results i.e. based on wider selection of packaging materials or different lead times, etc. (170 and 172). If the transaction is approved, the invention will produce a work order to whoever is designated as the packager and shipper. Typically the seller, or 3^{rd} party selected by the seller (174 and 176). This work order will provide a set of instructions on how to package and ship the given order. The instructions may also be visual in nature in order to better describe the orientation of items to be packed.

If the transaction is not accepted, and either the buyer or seller do not wish to recalculate or reconfigure the variables associated with the product mix, the process ends (178).

An example of how the invention could work to benefit of a user is as follows: Joel, who lives in California, likes to auction car parts on his favorite auction website. One day, a potential buyer, John makes a bid for some car parts that Joel is auctioning—only he offers a price for the car parts that must include the cost of delivering to his location in Florida. Sara also makes a bid, but her price is not is good as John's and she lives in Texas. The auction site uses the present invention as a convenience to it's members and has also designated a 3^{rd} party packaging and shipping business that will package and ship items for a small fee for members like Joel. The packaging and shipping outlet also has a location very close to Joel. Joel then uses the present invention and determines that selling the goods to Sarah is the best deal for him because of the difference in the packing and shipping costs between John's and Sarah's offer. In fact, Joel is so pleased with how low the packaging and shipping cost to Sarah is, he realizes the efficiency in packaging and shipping outlet doing it for him and also because of the selection of packaging materials they have available that he doesn't need to carry. He also feels assured his parts will also arrive safely to Sarah's home. All he needs to do is tomorrow drop-off the car parts he sold to Sarah at the packaging and shipping outlet located next him.

Although several embodiments have been described in detail for purposes of illustration, various modifications may be made without departing from the scope and spirit of the invention. Accordingly, the invention is not to be limited, except as by the appended claims.

What is claimed is:

1. An automated process for determining an optimal packaging configuration and freight mode for goods to be shipped, the process comprising the steps of:
obtaining order information including the availability of the goods and a delivery time in which the goods must reach a given destination;
determining one or more packaging configurations for the goods;
calculating packaging material and labor costs for the one or more packaging configurations;
determining dimensions and weights of goods and packaging materials for the one or more packaging configurations;
rating transport load options for the one or more packaging configurations against available carrier freight modes for delivery of the packaging configurations by the delivery time;
providing a cost for each transport load option; and selecting the optimal transport load option.

2. The process of claim 1, including the step of retrieving physical characteristics of the goods, including dimension and weight of the goods.

3. The process of claim 1, including the step of determining the type and amount of packaging material requirements for the one or more packaging configurations.

4. The process of claim 1, wherein the rating step includes taking into consideration all appropriate rules per carrier.

5. The process of claim 1, wherein the optimal transport load is selected before consummating the underlying order transaction.

6. The process of claim 1, including the step of determining whether the goods have a predetermined packaging specification.

7. The process of claim 6, wherein the packaging specification is retrieved from a database.

8. The process of claim 6, wherein the one or more packaging configurations are based on the packaging specification.

9. The process of claim 1, including the step of determining any applicable unit packaging specifications for the goods.

10. The process of claim 9, wherein the unit packaging specifications are retrieved from a database.

11. The process of claim 9, wherein the one or more packaging configurations are based on the applicable unit packaging specifications for the goods.

12. The process of claim 1, including the step of determining whether the goods require additional packaging based on physical characteristics of the goods or a buyer's requirements.

13. The process of claim 1, wherein the one or more packaging configurations are based on the physical characteristics of the goods and the amount of goods.

14. The process of claim 1, including the step of evaluating packaging inventory to determine if adequate materials are in inventory for the one or more packaging configurations.

15. The process of claim 14, including the step of determining whether to use a third party for packaging and shipping.

16. The process of claim 15, wherein when using a third party, including the step of retrieving the third party's packaging materials inventory, freight rates and options available, labor rates and applicable service fees.

17. An automated process for determining an optimal packaging configuration and freight mode for goods to be shipped, the process comprising the steps of:
obtaining order information including the availability of the goods and a delivery time in which the goods must reach a given destination;
retrieving physical characteristics of the goods, including dimension and weight of the goods;
determining one or more packaging configurations for the goods;
determining the type and amount of packaging material requirements for the one or more packaging configurations;
calculating packaging material and labor costs for the one or more packaging configurations;
determining the combined dimension and weight of goods and packaging materials for the one or more packaging configurations;
rating all transport load options for the one or more packaging configurations against available carrier freight modes for delivery of the packaging configurations by the delivery time, taking into consideration all appropriate rules per carrier;
providing a cost for each transport load option before consummating the underlying order transaction; and
selecting the optimal transport load option.

18. The process of claim 17, including the step of determining whether the goods have a predetermined packaging specification.

19. The process of claim 18, wherein the packaging specification is retrieved from a database.

20. The process of claim 18, wherein the one or more packaging configurations are based on the packaging specification.

21. The process of claim 17, including the step of determining any applicable unit packaging specifications for the goods.

22. The process of claim 21, wherein the unit packaging specifications are retrieved from a database.

23. The process of claim 21, wherein the one or more packaging configurations are based on the applicable unit packaging specifications for the goods.

24. The process of claim 17, including the step of determining whether the goods require additional packaging based on physical characteristics of the goods or a buyer's requirements.

25. The process of claim 17, wherein the one or more packaging configurations are based on the physical characteristics of the goods and the amount of goods.

26. The process of claim 17, including the step of evaluating packaging inventory to determine if adequate materials are in inventory for the one or more packaging configurations.

27. The process of claim 26, including the step of determining whether to use a third party for packaging and shipping.

28. The process of claim 27, wherein when using a third party, including the step of retrieving the third party's packaging materials inventory, freight rates and options available, labor rates and applicable service fees.

29. An automated process for determining an optimal packaging configuration and freight mode for goods to be shipped, the process comprising the steps of:
obtaining order information including the availability of the goods and the delivery time in which the goods must reach a given destination;
retrieving physical characteristics of the goods, including dimension and weight of the goods;
determining whether a predetermined packaging specification applies to the goods;
determining any applicable unit packaging specifications that apply to the goods;
determining one or more packaging configurations for the goods based on the physical characteristics of the goods, amount of the goods, and any applicable packaging or unit packaging specifications;
determining the type and amount of packaging material requirements for the one or more packaging configurations;
calculating packaging material and labor costs for the one or more packaging configurations;
determining the combined dimension and weight of goods and packaging materials for the one or more packaging configurations;
rating transport load options for the one or more packaging configurations against available carrier freight modes for delivery of the packaging configurations by the delivery time, taking into consideration all appropriate rules per carrier;
providing a cost for each transport load option before consummating the underlying order transaction; and
selecting the optimal transport load option.

30. The process of claim 29, wherein the packaging specification is retrieved from a database.

31. The process of claim 29, wherein the one or more packaging configurations are based on the packaging specification.

32. The process of claim 29, wherein the unit packaging specifications are retrieved from a database.

33. The process of claim 29, wherein the one or more packaging configurations are based on the applicable unit packaging specifications for the goods.

34. The process of claim 29, including the step of determining whether the goods require additional packaging based on physical characteristics of the goods or a buyer's requirements.

35. The process of claim 29, including the step of evaluating packaging inventory to determine if adequate materials are in inventory for the one or more packaging configurations.

36. The process of claim 29, including the step of determining whether to use a third party for packaging and shipping.

37. The process of claim 36, wherein when using a third party, including the step of retrieving the third party's packaging materials inventory, freight rates and options available, labor rates and applicable service fees.
